(19) United States
(12) Patent Application Publication
(10) Pub. No.: US 2010/0166358 A1
(43) Pub. Date: Jul. 1, 2010

(54) Dual Fiber Grating and Methods of Making and Using Same

(76) Inventors: Daniel Homa, Blacksburg, VA (US); Brooks Childers, Christiansburg, VA (US)

Correspondence Address: R. PERRY MCCONNELL, P.C., 9001 FOREST CROSSING, SUITE F, THE WOODLANDS, TX, 77381, US

(21) Appl. No.: 12/346,164

(22) Filed: Dec. 30, 2008

(51) Int. Cl. G02B 6/00; B29D 11/00

(52) U.S. Cl. 385/12; 264/1.24; 264/1.27

(57) ABSTRACT

A multiple-layer fiber-optic sensor is described with dual Bragg gratings in layers of different materials, so that the known temperature and strain response properties of each material may be utilized to simultaneously correct the sensor output for temperature and strain effects.

### FIELD OF THE INVENTION

Then invention concerns fiber-optic sensors that can simultaneously compensate for temperature and strain.

### BACKGROUND OF THE INVENTION

Fiber-optic sensors, particularly those using Bragg gratings, are often utilized in harsh environments such as downhole environments. However, Bragg grating sensors are generally simultaneously susceptible to effects from temperature and strain that cause offsets to the sensors' calibration. This dual susceptibility hampers independent measurements of these properties when the sensor's environment imposes such conditions simultaneously.

These offset effects, due to measurement sensitivity to two variables, can be eliminated by making a second, simultaneous measurement using a second sensor. To do so, however, it is important that both sensors be located as closely together as possible, so that both sensors are simultaneously subject to identical conditions, or near-identical, conditions.

However, even close location of multiple sensors can be insufficient to completely isolate these simultaneous effects. Multi-core optical sensors have been previously introduced, as in U.S. Pat. No. 7,310,456 to Childers, and U.S. Pat. No. 7,379,631 to Poland, et al. These patents disclose optical sensors with multiple, parallel cores, in which multiple Bragg gratings are inscribed. Because these Bragg gratings may be effectively co-located at the same position along the sensor, such parallel-core sensors may be used to take multiple measurements from nearly the same location.

However, it is desirable to construct a sensor that provides complete co-location of multiple measurements, thus insuring that simultaneous measurements are acquired under as nearly identical conditions as possible.

It is further desirable to construct a co-located multiple sensor in which the component sensors provide different, measurable, physical responses to temperature and strain phenomena.

It is further desirable to provide such a sensor of a construction that will endure harsh conditions, such as those of a downhole environment.

### SUMMARY OF THE INVENTION

The invention comprises a fiber optic sensor with concentric, co-axial, multiple cylindrical layers, constructed so that at least two of the layers are comprised of different photosensitive materials, thus providing an inner photosensitive layer and an outer photosensitive layer. A Bragg grating is photo-etched into these materials, so that the sensor has Bragg gratings on multiple layers, co-located relative to the longitudinal axis of the fiber. The photosensitive core layers are separated by an intermediate layer, preferably comprising a relatively large pure silica layer that is largely non-photosensitive.

The inner and outer photosensitive layers will comprise different photosensitive materials. The inner photosensitive layer will preferably consist of a material such as GeO₂, Al₂O₃, boron-doped silica, or a selectively co-doped material. The outer photosensitive layer will preferably consist of SnO₂, GeO₂, or another photosensitive, doped material that is different from the material of the inner photosensitive layer.

The outer photosensitive layer, the intermediate layer, and the inner photosensitive layer are preferably deposited in sequence on the surface of a preform via chemical vapor deposition (“CVD”). Those of skill in the art will recognized that various CVD methods may be utilized, and that the choice of such methods is a matter of engineering preference.

After pulling the fiber, Bragg gratings are formed in the outer photosensitive layer and the inner photosensitive layer by exposure to ultraviolet (“UV”) light. This exposure will preferably be accomplished via masking and use of an essentially parallel UV light source, so that the Bragg gratings formed in the inner photosensitive layer and the outer photosensitive layer will be essentially identical and at the same position relative to the longitudinal axis of the fiber. However, those of skill in the art will recognize that interference techniques may be utilized to expose the inner and outer photosensitive layers to form a practical device of the current invention. Accordingly, the method of exposure is considered to be a matter of engineering choice and not a limitation of the invention.

The Bragg gratings formed by this UV exposure will provide essentially parallel Bragg gratings in multiple layers of the fiber optic. These gratings will have characteristic resonant wavelengths:

λ_{B}=2nΛ,

where n is the effective refractive index of the grating, and Λ is the grating period. However, because the inner photosensitive layer and the outer photosensitive layer are comprised of different materials, their respective Bragg wavelengths, and thus their respective responses to fluctuations or changes in temperature and strain will produce different optical responses to these stimuli.

In an alternative embodiment, the fiber maybe a dual-mode fiber, preferably utilizing LP11 and LP01 modes. In this alternative embodiment, the first mode responds to the grating at the inner-most layer, and the second mode responds to the grating in the outer layer. Again, respective responses of the two modes to the gratings in the different layers will provide different optical responses to temperature and strain stimuli.

Accordingly, the present invention provides at least a two-valued output in response to a two-variable environment, and allows resolution of both the temperature and strain fluctuations in the measured environment. Use of the present invention thus involves the observation or recording of essentially simultaneous responses from the Bragg gratings from each Bragg grating layer, and utilizing known mathematical methods to resolve the simultaneous external strain and temperature imposed on the sensor by its environment.

### BRIEF DESCRIPTION OF THE DRAWINGS

FIG. 1 is a cross-sectional view of a preform for use in forming an embodiment of a fiber optic sensor of the present invention.

FIG. 2A is a schematic cross-sectional side view of the ultraviolet exposure of one embodiment of a fiber optic of the present invention.

FIG. 2B is a schematic cross-sectional side view of Bragg gratings formed in an embodiment of a fiber optic of the present invention.

### DETAILED DESCRIPTION

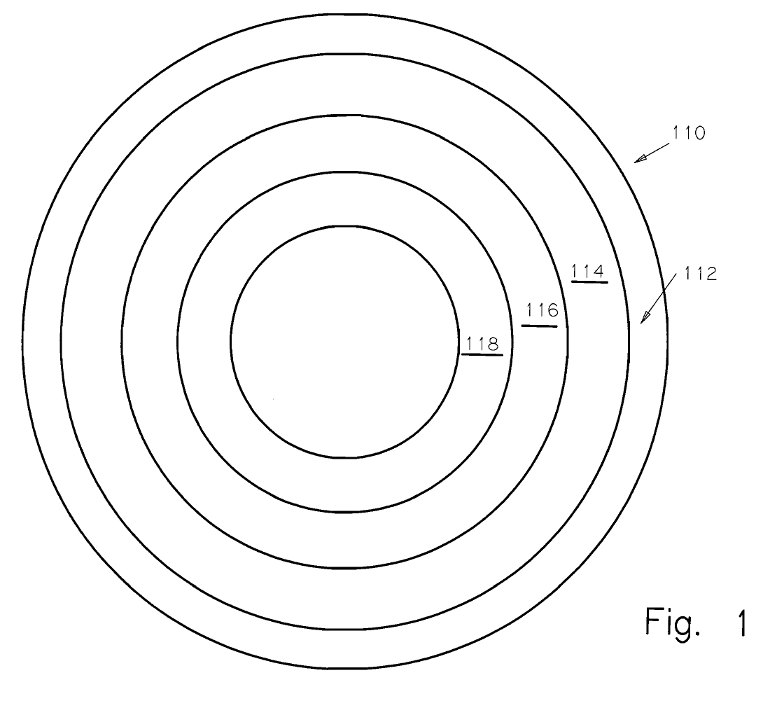

Referring to FIG. 1, a cross-sectional view of a preform for use in forming an embodiment of a fiber optic sensor of the present invention is shown. Preform 110 comprises an outer silica cylindrical shell 112, an outer photosensitive layer 114, an intermediate layer 116, and an inner photosensitive layer 118. Outer photosensitive layer 114, intermediate layer 116, and inner photosensitive layer 118 are preferably deposited by CVD, beginning with outer photosensitive layer 114 on the inner surface of outer silica cylindrical shell 112, and continuing as deposited layers on the inner surfaces of each layer in sequence. Those of skill in the art will also recognize that it is possible to build “from the inside out,” as opposed to “from the outside in,” as a matter of engineering choice.

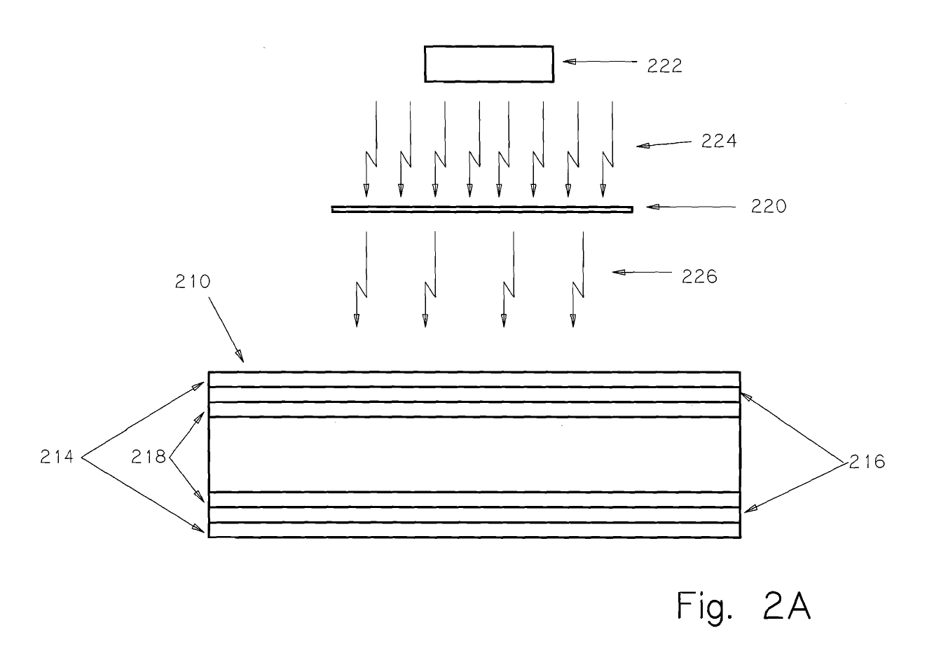

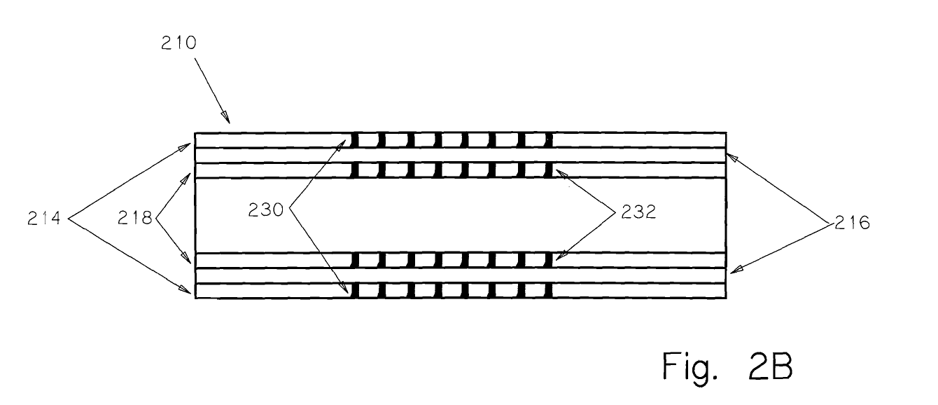

Inner photosensitive layer 118 will preferably consist of a material such as GeO₂, Al₂O₃, boron-doped silica, or a selectively co-doped material. Outer photosensitive layer 114 will preferably consist of SnO₂, GeO₂, or another photosensitive, doped material that is different from the material of the inner photosensitive layer 118. Intermediate layer 116 preferably comprises a large (in relation to inner photosensitive layer 118 and outer photosensitive layer 114, although scale is not depicted in FIGS. 1, 2A, or 2B), essentially pure silica layer that is essentially not photosensitive.

As those of skill in the art will recognize, after the preform 110 and its respective layers 112-118 are complete, the preform 110 may be pulled by techniques known in the art to form an optical fiber, as depicted as 210 in FIG. 2.

Referring to FIG. 2A, optical fiber 210 comprises outer photosensitive layer 214, intermediate layer 216, and inner photosensitive layer 218, corresponding to preform layers 114, 116, and 118 of FIG. 1. The desired Bragg gratings are created at selected longitudinal positions along optical fiber 210 by illuminating UV light source 222 that preferably produces essentially parallel UV light 224, and which is patterned into the desired Bragg grating pattern by mask 220. Patterned UV light 226 impinges on all layers of optical fiber 210, in particular on outer photosensitive layer 214 and inner photosensitive layer 218.

Referring now to FIG. 2B, after the desired UV exposure period is completed, outer photosensitive layer 214 and inner photosensitive layer 218 will comprise essentially identical Bragg gratings 230 and 232, respectively. However, as discussed above, because outer photosensitive layer 214 and inner photosensitive layer 218 are comprised of differently composed materials, Bragg gratings 230 and 232 will have differing resonant wavelengths.

Those of skill in the art will recognize that, rather than utilizing mask 220, it may be possible to produce Bragg gratings 230 and 232 utilizing multiple UV sources and an interference method (not shown). However, the angular divergence of the UV sources utilizing such a method impose limitations on how closely identically Bragg gratings 230 and 232 may be formed, and this approach is not preferred.

The above examples are included for demonstration purposes only and not as limitations on the scope of the invention. Other variations in the construction of the invention may be made without departing from the spirit of the invention, and those of skill in the art will recognize that these descriptions are provided by way of example only.

We claim:

1. A fiber optic sensor for use in simultaneously measuring temperature and strain variations, comprising
a first layer, comprising a first material and a first Bragg grating,
a second layer concentric with said first layer and comprising a second material and a second Bragg grating, wherein said first Bragg grating and said second Bragg grating are essentially identically patterned and are co-located along the longitudinal axis of the fiber optic sensor, and
a third layer concentric with and intermediate said first layer and said second layer, wherein said third layer comprises a material different than said first and second layers.

2. The fiber optic sensor of claim 1, wherein said first layer comprises GeO₂, Al₂O₃, boron-doped silica, or a selectively co-doped material.

3. The fiber optic sensor of claim 1, wherein said second layer comprises SnO₂, GeO₂, or another photosensitive, doped material.

4. The fiber optic sensor of claim 1, wherein said third layer comprises an essentially pure silica layer that is essentially not photosensitive.

5. The fiber optic sensor of claim 1, wherein said fiber is a dual mode fiber.

6. The fiber optic sensor of claim 5, wherein said fiber transmits LP01 and LP11 modes.

7. A method of constructing a fiber optic sensor for simultaneously measuring temperature and strain deviations, comprising the steps of
providing a fiber optic preform,
depositing a first layer of a first photosensitive material on a surface of said preform, wherein after deposition said first layer comprises a first exposed surface,
depositing an intermediate layer of an essentially non-photosensitive material on said first exposed surface, wherein after deposition said intermediate layer comprises a second exposed surface,
depositing a second layer of a second photosensitive material on said second exposed surface,
pulling said preform into a fiber optic,
forming essentially identically-patterned Bragg gratings in said first layer and said third layer at essentially the same longitudinal position along said fiber optic.

8. The method of claim 7, additionally comprising the step of selecting the material for said first layer from the group of SnO₂, GeO₂, or another photosensitive, doped material.

9. The method of claim 7, additionally comprising the step of selecting the material for said second layer from the group of GeO₂, Al₂O₃, boron-doped silica, or a selectively co-doped material.

10. The method of claim 7, wherein the step of forming essentially identically-patterned Bragg gratings in said first layer and said third layer at essentially the same longitudinal position along said fiber optic additionally comprises the step of utilizing a source of ultraviolet light to form said Bragg gratings.

11. The method of claim 10, additionally comprising the step of positioning a mask between said source of ultraviolet light and said fiber optic.

12. A method of determining strain and temperature imposed on a sensor by its environment, wherein said sensor comprises at least two essentially concentric Bragg gratings formed in different materials, comprising the steps of observing essentially simultaneous responses from said Bragg gratings, and mathematically resolving values for temperature and strain imposed on said sensor from the responses of said Bragg gratings.

13. The method of claim 12, additionally comprising the step of recording said responses from said Bragg gratings.
